(19) United States
(12) Patent Application Publication
(10) Pub. No.: US 2026/0165254 A1
(43) Pub. Date: Jun. 18, 2026

(54) SIMPLIFIED COMBINE HARVESTER

(71) Applicant: Alexis Zeigler, Louisa, VA (US)

(72) Inventor: Alexis Zeigler, Louisa, VA (US)

(21) Appl. No.: 18/277,830

(22) PCT Filed: Aug. 17, 2023
(86) PCT No.: PCT/US2023/030423

§ 371 Date: Aug. 18, 2023

(51) Int. Cl. A01F 12/10; A01F 7/04; A01F 12/20

(52) U.S. Cl. CPC A01F 12/10; A01F 7/04; A01F 12/20

(57) ABSTRACT

Certain exemplary embodiments provide a simplified combine harvester. The simplified combine harvester can comprise an intake and grain separating draper and a thresher-conveyance apparatus. The intake and grain separating draper can protrude from a front of the simplified combine harvester and functions to both bend the grain stalks down into the simplified combine harvester on the underside and to separate the grain from straw and chaff on the upper side. The thresher-conveyance apparatus both conveys stalks of grain through the combine harvester and threshes the grain from the stalks.

### CROSS-REFERENCES TO RELATED APPLICATIONS

This application claims priority to, and incorporates by reference herein in its entirety, pending United States Provisional Patent Application Serial No. 63/521,354, filed Jun. 16, 2023.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 illustrates internal working mechanisms of a simplified combine harvester 1000 without outer shielding in place;

FIG. 2 is a top-down view of a pull type simplified combine harvester 2000;

FIG. 3 is a side view of the simplified combine harvester with shields in place;

FIG. 4 is a side view of the intake and grain separating draper portion of the simplified combine harvester with shields in place;

FIG. 5 shows various options for thresher and impedance bars;

FIG. 6 shows the intake and grain separating draper, top-down view, wide and narrow configurations; and

FIG. 7 illustrates the use of multiple thresher-conveyance apparatus 7000 as illustrated in FIG. 1 on a large combine harvester.

### DETAILED DESCRIPTION

Certain exemplary embodiments provide a simplified combine harvester. The simplified combine harvester can comprise an intake and grain separating draper and a thresher-conveyance apparatus. The intake and grain separating draper can protrude from a front of the simplified combine harvester. A top of the intake and grain separating draper is high enough to reach a top of grain stalks. The intake and grain separating draper constructed to bend the grain stalks down into the simplified combine harvester.

Certain exemplary embodiments provide a combine harvester that is inexpensive and effective such that small farmers around the world may have access to mechanical devices and systems to harvest their crops.

People everywhere rely on grain for food, and there are thousands of patents related to grain harvesting equipment. The simplest methods involve harvesting by hand, or with various reaper-binders, and carrying the grain stalks to a stationary thresher. Farms in the Far East are smaller, and various small and micro-combine harvesters are manufactured in China and India. These machines are a miniaturization of the large machines first developed in the United States, Australia, and Europe. There are also numerous stripper combines, both historic and contemporary.

Harvesting by hand, or with various reaper-binders, and carrying the grain stalks to a stationary thresher, is slow and labor intensive. Using such methods, grain is lost in handling, as well as to bad weather, and consumption by animals. Most grain is harvested by very large, expensive machines which small and low-income farmers cannot afford. Certain micro-combines can be complex, inefficient in the harvest of grain, clog easily, cannot harvest tall grain, and will not function on sloped ground. Micro-combines can be unhealthy for an operator to use (because of smoke from the engine and dust) and can cost thousands of dollars. Combine harvesters using strippers can be relatively expensive and can be restricted to particular types of grains. Strippers can have difficulty harvesting grain that has been partially or fully blown over (“lodged”) or is of uneven height. In short, small farmers worldwide could benefit from reliable, economical, and effective grain harvesting equipment. Small farmers all over the world can benefit from exemplary embodiments disclosed herein.

The inventors have spent years researching and experimenting to build a simplified combine harvester. The inventors have a fully operational prototype that is, to their knowledge, much simpler than any combine harvester ever constructed, and harvests wheat effectively in field tests.

Two specific mechanisms have been developed to achieve the goal of building a simplified combine harvester, those being a thresher-conveyance apparatus and an intake and grain separating draper. As the simplified combine harvester moves through a field, the grain stalks are pushed into the combine by the intake and grain separating draper (hereinafter “the draper,” or “draper”), similar to how a reel on a header on other combines pushes the standing grain stalks into the header. The sloped draper pushes the grown stalks downward, leaning them such that the grains stalks enter combine harvester grain headfirst, whereupon they come into contact with the thresher-conveyance apparatus.

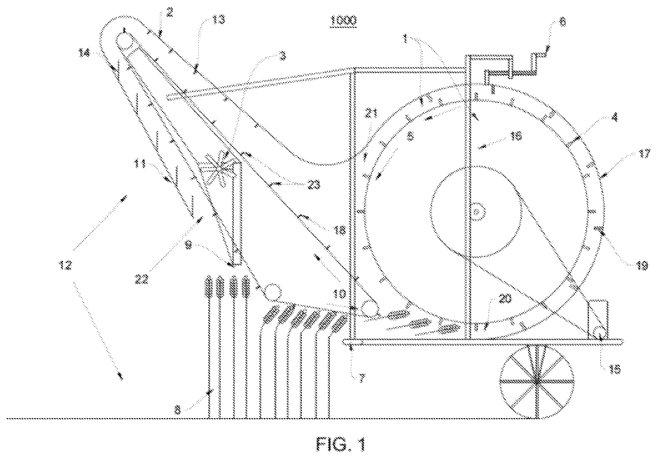

FIG. 1 illustrates internal working mechanisms of a simplified combine harvester 1000 without outer shielding in place. This illustration shows a ‘pull type’ combine of small size. Larger and self-propelled machines can be built using the same mechanisms with some modification.
a first thresher-conveyance apparatus 1;
intake and grain separating draper 2;
fan 3;
thresher bars 4;
direction of rotation 5;
outer shell adjustment 6, which increases and decreases gap between thresher and impedance bars, thus increasing and decreasing an intensity of threshing;
sickle bar cutter 7;
grain stalks 8;
grain expulsion location 9;
direction of motion 10;
straw expulsion location 11;
a grain intake area 12 allows for the harvest of a variety of grains;
draper impedance bars 13;
straw expulsion bars 14;
motor 15;
rotating drum 16;
a shell 17;
impedance bars 19; and draper conveyance bars 23.

In certain exemplary embodiments, simplified combine harvester 1000 can be ground driven.

Simplified combine harvester 1000 is constructed to harvest grain from grain stalks 8.

The first thresher-conveyance apparatus comprises rotating drum 16, which is a large, spinning, drum, or similarly shaped device, (hereinafter “the drum,” or “drum).

Simplified combine harvester 1000 comprises:
an intake and grain separating draper 2; intake and grain separating draper 2 protrudes from a front of simplified combine harvester 1000; a top of intake and grain separating draper 2 can be high enough to reach a top of grain stalks 8; intake and grain separating draper 2 is constructed to bend grain stalks down into simplified combine harvester 1000;
a first thresher-conveyance apparatus 1, which can comprise:
   a sickle bar cutter 7, which is constructed to cut grain stalks as the grain stalks enter first thresher-conveyor apparatus 1; and
   a rotating drum 16, which is at least partially surrounded by a shell 17; the rotating drum 16 is constructed to draw grain stalks 8 into first thresher-conveyance apparatus 1, threshes grain stalks 8 between rotating drum 16 and shell 17 as grain stalks 8 travel around and upward around rotating drum 16, wherein straw, grain, and chaff are expelled at a top of rotating drum 16.

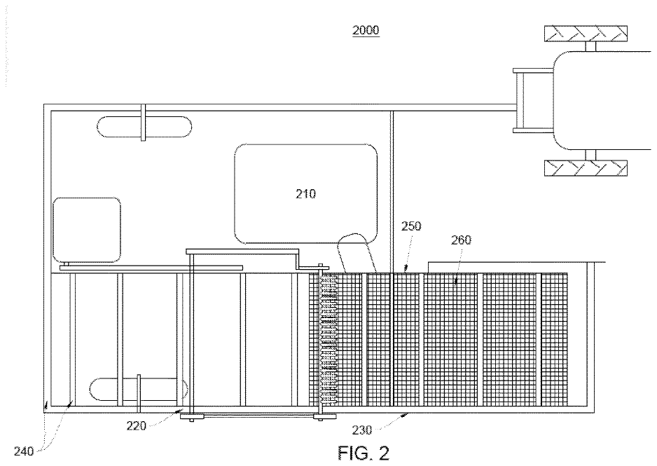

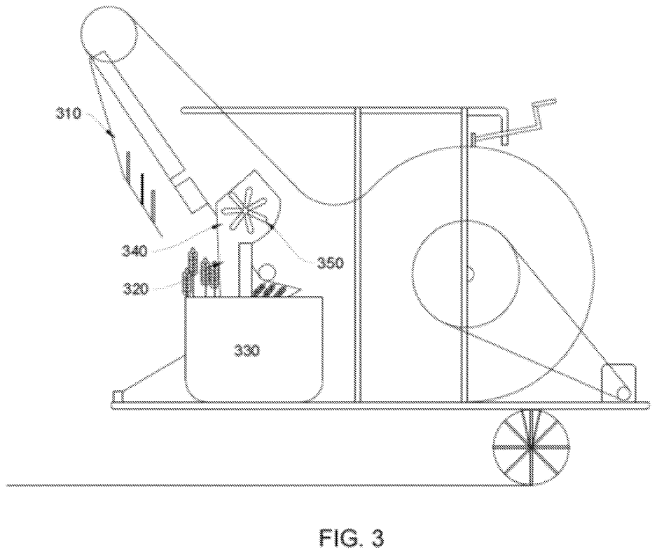

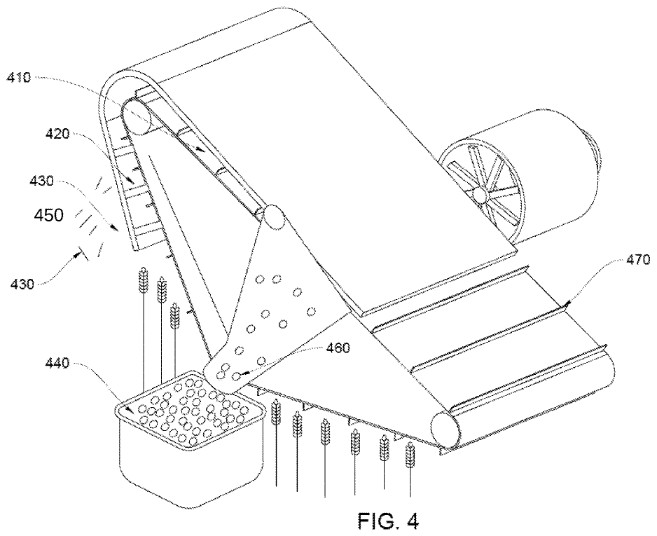

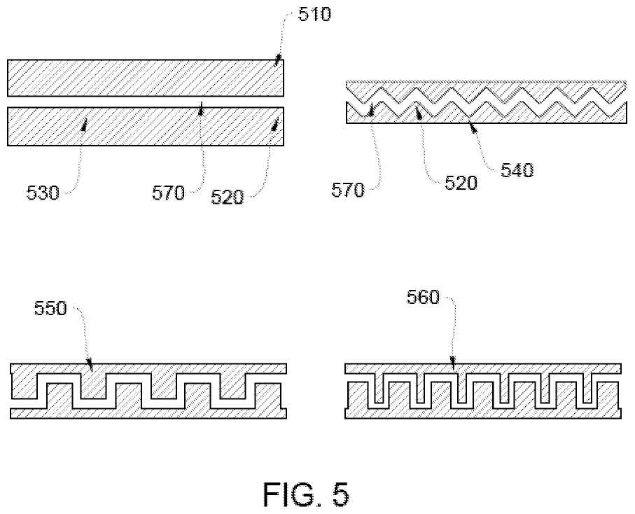

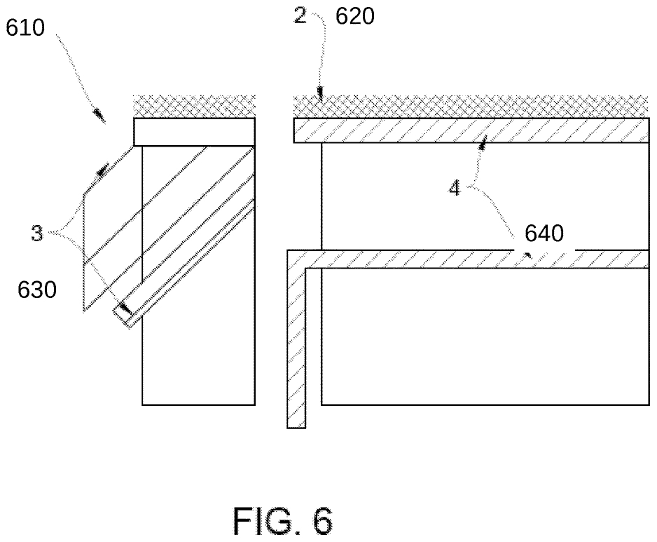

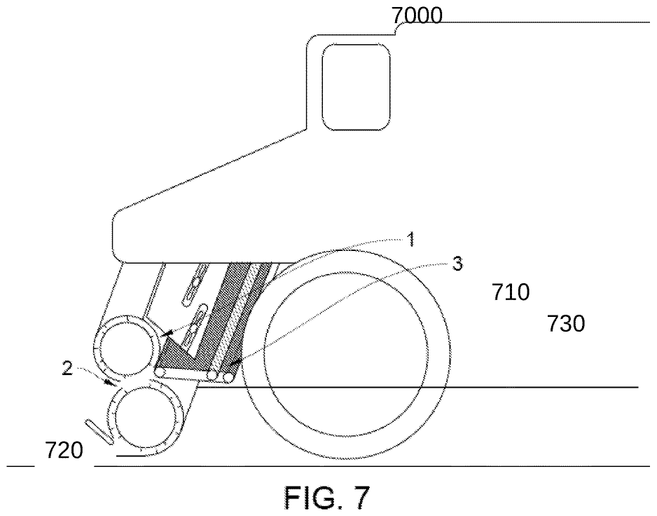

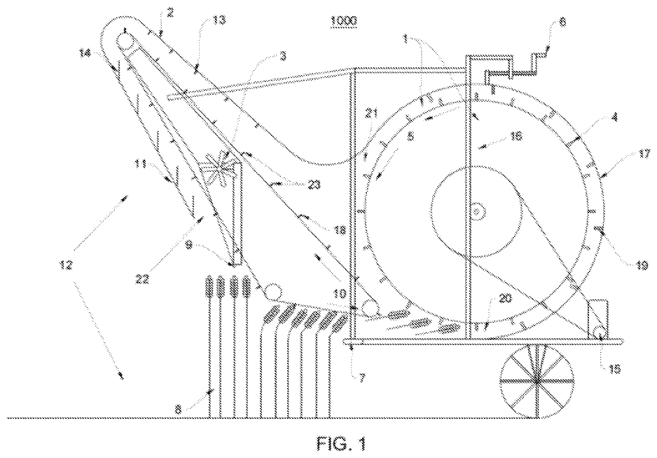

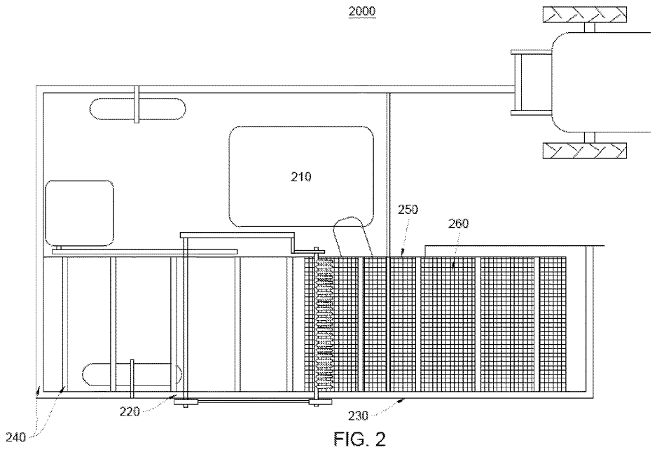

Intake and grain separating draper 2 can have draper conveyance bars 18 that facilitate both pushing grain stalks into simplified combine harvester 1000 on a lower side and pushing straw up and away from simplified combine harvester 1000 on an upper side. Intake and grain separating draper 2 can comprises a mesh and/or netting (see, e.g., mesh, netting, or similar material 250 of FIG. 2). Intake and grain separating draper 2 moves in direction of motion 10 in the illustrated embodiment.

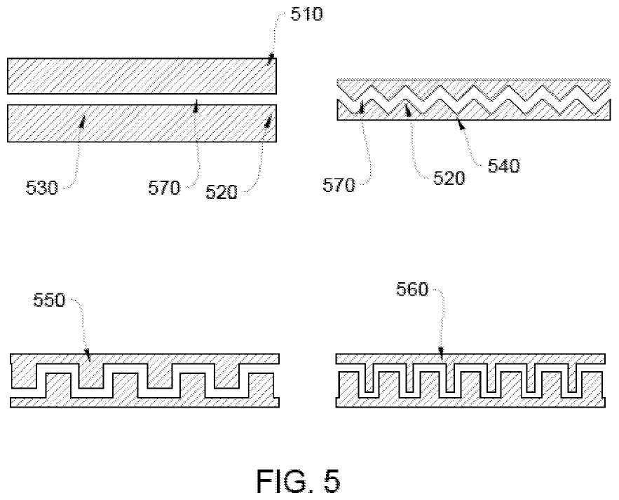

Rotating drum 16 can comprise thresher bars 4 and/or flails. Rotating drum 16 moves in direction of rotation 5 in the illustrated embodiment. In certain exemplary embodiments, a rotational velocity of rotating drum 16 is adjustable by the user. Shell 17 can comprise impedance bars 19, which can be adjustable inward, outward, toward, and away from rotating drum 16 by the user. Thresher bars 4 and/or impedance bars 19 comprise angled or notched materials (see, e.g., FIG. 5) such that the thresher bars and the impedance bars pass through each other without contact as rotating drum 16 rotates. Thresher bars 4 can be substantially continuous along a width of rotating drum 16. Impedance bars 19 can be substantially continuous along a width of shell 17. An outer shell adjustment 6 can change threshing intensity.

Shell 17 can define a first aperture 20 close to ground level where grain stalks are pulled in, and a second aperture 21 at a top of the rotating drum where grain, straw, and chaff are expelled.

Intake and grain separating draper 2 can be constructed to:
push standing grain stalks downward;
cause the standing grain stalks to lean into a thresher; and/or the standing grain stalks to enter simplified combine harvester 1000 headfirst, whereupon the standing grain stalks come into contact with first thresher-conveyance apparatus 1.

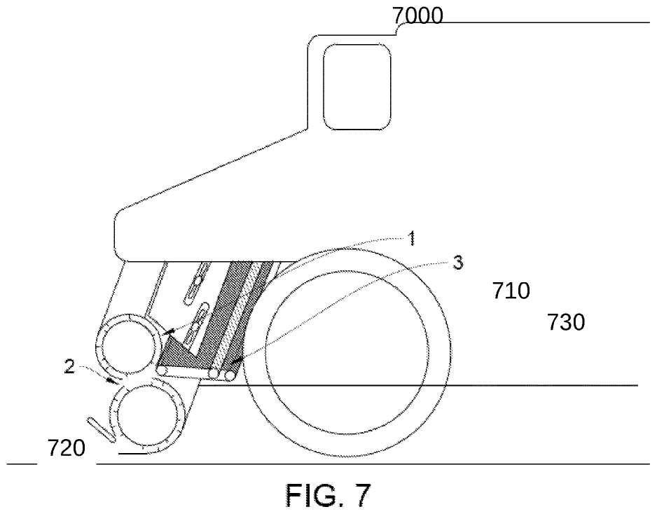

Certain exemplary embodiments utilize a second thresher-conveyance apparatus (see, e.g., FIG. 7), the second thresher-conveyance apparatus constructed to expel straw, grain, and chaff toward a rear of the simplified combine harvester.

In certain exemplary embodiments, simplified combine harvester 1000 can be self-propelled.

Certain exemplary embodiments utilize a fan 3 that is constructed to blow air through falling grain to remove chaff from grain.

Simplified combine harvester 1000 can be constructed to:
harvest grains;
strip grain heads; and/or operate as a stripper without sickle bar cutter 7.

Straw is expelled via straw expulsion location 11. A high grain intake area 12 allows the harvest of many kinds of grain under varying conditions. Grain is expelled via grain expulsion location 9.

FIG. 2 is a top-down view of a pull type simplified combine harvester 2000, which comprises:
a grain catchment 210;
thresher-conveyance apparatus 220;
an intake and grain separating draper 230; and
thresher and impedance bars 240.

The configuration and placement of thresher and impedance bars 240 are determined to achieve proper threshing. Simplified combine harvester 2000 is constructed to harvest standing grain.

Intake and grain separating draper 230 comprises a mesh, netting, or similar material 250. Grain falls through apertures in mesh, netting, or similar material 250 as the draper travels beyond a shelf. A larger combine can have a horizontal (not sloping) shelf and an open-top augur or similar mechanism. Intake and grain separating draper 230 defines apertures 260 sized such that grain passes through apertures 260. Straw travels beyond the top of intake and grain separating draper 230 and is expelled via a first sloping trough.

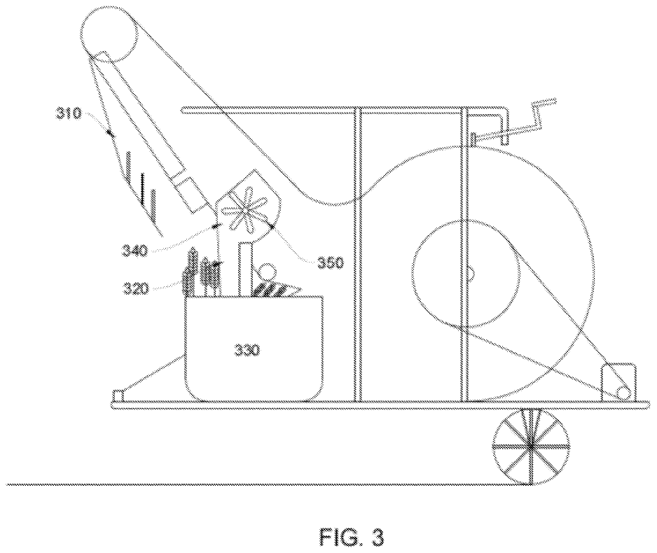

FIG. 3 is a side view of the simplified combine harvester with shields in place.

FIG. 3 illustrates:
a straw expulsion location 310;
a grain expulsion location 320;
a grain catchment 330; and
a trough 340.

Grain and some chaff fall through the holes in the upper part of the draper. The grain falls to trough 340 whereas the chaff is blown away by a fan 350.

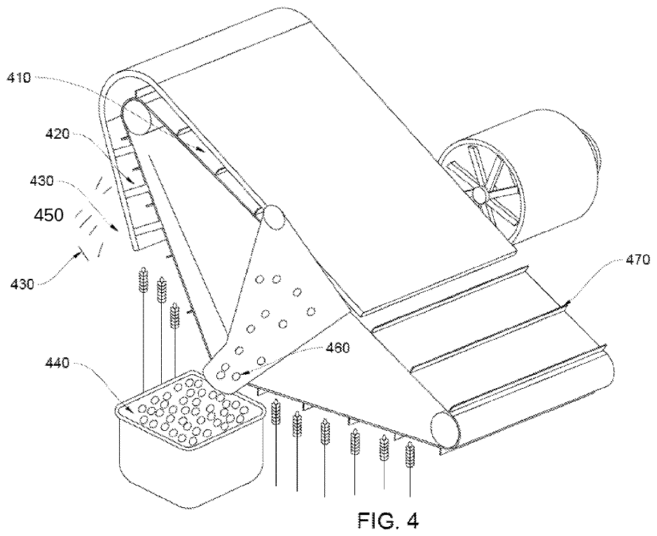

FIG. 4 is a side view of the intake and grain separating draper portion of the simplified combine harvester with shields in place. FIG. 4 illustrates:
draper impedance bars 410;
straw expulsion bars 420 bars, which are at a sharp angle (approximately 45 degrees or more) relative to draper conveyance bars 470 and push straw 430 out of a side of a draper;
straw 430; and
grain 440.

Draper impedance bars 410 cause straw 430 to roll as it proceeds up the draper, thus facilitating the extraction of grain 440. Draper impedance bars 410 are parallel to draper conveyance bars.

Straw expulsion bars 420 bars are at a sharp angle (45 degrees or more) relative to draper conveyance bars 470 and push straw 430 out of a side of the draper.

FIG. 4 illustrates a first sloping trough 450 and a second sloping trough 460, which are used to separate and move grain and straw on a combine harvester.

FIG. 5 shows various options for thresher and impedance bars. FIG. 5 illustrates:
thresher bars 510, which are mounted onto a drum in a thresher conveyance apparatus;
impedance bars 520, which are mounted to a shell around the drum as part of the thresher conveyance apparatus and are stationary;
flat bars 530;
bars 540 with angle notches for more aggressive threshing;
bars 550 with square notches for aggressive threshing;
flails 560—if flails are used, flails 560 are coupled to mobile thresher bars 510 and not stationary impedance bars 520; and
grain, straw, and chaff pass between a gap 570 between thresher bars 510 and impedance bars 520.

Adjusting the bars closer together provides for more aggressive threshing.

Adjusting the bars further apart provides for less aggressive threshing.

FIG. 5 illustrates sectional views of certain exemplary threshing components (labeled thresher bars and impedance bars) of a thresher-conveyance apparatus, including those of both a drum and an outer shell. Certain exemplary embodiments utilize flat bars 530 (flat bars 530 were utilized in a prototype of the inventors). Other exemplary embodiments can utilize bars 540 with angled notches, which facilitate a more aggressive threshing, but can clog more easily.

Flat bars 530 and bars 540 with angled notches comprise thresher bars 510 and impedance bars 520. Grain, straw, and chaff passes between thresher bars 510 and impedance bars 520. Adjusting gap 570 to make such gap narrower can result in more aggressive threshing. Adjusting gap 570 further apart provides for less aggressive threshing.

An exemplary embodiment of a first set bars 550 with square notches is illustrated in FIG. 5. Another exemplary embodiment of a second set of bars 550 with square notches is illustrated in FIG. 5. If flails are used, they are coupled to thresher bars, not impedance bars.

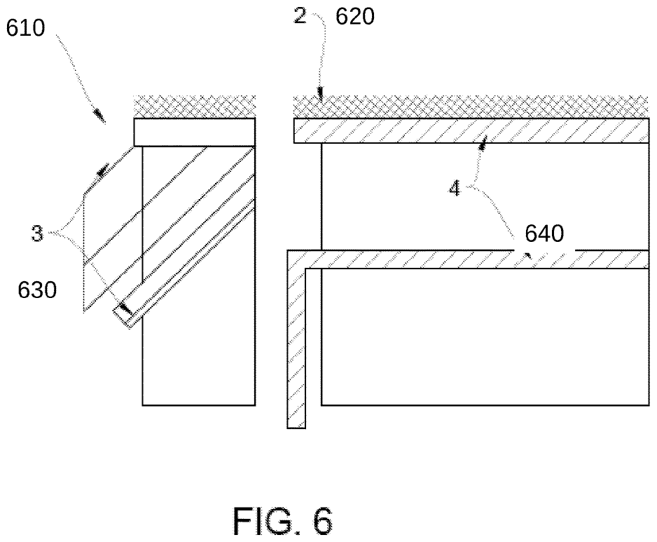

FIG. 6 shows the intake and grain separating draper, top-down view, wide and narrow configurations. FIG. 6 illustrates:
a top-down view of intake and grain separating draper 610 as used on a small combine harvester (small is defined as approximately three feet or approximately one meter in width);
modifications 620 that can be utilized to implement such technology on combine harvesters wider than approximately three feet or approximately one meter in width;
sloped troughs 630 move straw and grain to the side of intake and grain separating draper 610 aided by gravity; and
conveyors, augurs, or similar mechanisms 640.

The illustrated modifications allow this technology to be used on much larger combines with the aid of conveyors, augurs, or similar mechanisms to move straw and grain to the side of intake and grain separating draper 610.

Intake and grain separating draper 610 is a relatively narrow draper in which straw and grain are expelled by troughs, aided by gravity. Sloped troughs 630 move the grain and straw to the side of intake and grain separating draper 610.

Modifications 620 utilize a wider draper which utilizes conveyors, augurs, or similar mechanisms 640 to push the grain and straw to the side of the draper, to be dispersed (as with the straw) or collected (as with the grain) as needed.

In certain exemplary embodiments, simplified combine harvesters comprise sloped troughs 630. Sloped troughs 630 can be constructed to move grain and straw.

Certain exemplary embodiments utilize one or more conveyors, augurs, or similar mechanisms 640. One or more conveyors, augurs, or similar mechanisms 640 are constructed to move grain, straw, and chaff through the simplified combine harvester.

FIG. 7 illustrates the use of multiple thresher-conveyance apparatus as illustrated in FIG. 1 on a large combine harvester. FIG. 7 illustrates:
two thresher-conveyance apparati 710 that are stacked;
a clog point 720;
a grain separating draper and lateral augur 730 similar to the intake and grain separating draper used on the simplified combine harvester, but other commonly employed grain separating mechanisms could be used as well.

A lower apparatus of two thresher-conveyance apparati 710 serves as the intake, and passes grain, straw and chaff on to an upper apparatus of two thresher-conveyance apparati 710. The upper apparatus expels the grain, straw and chaff toward the rear of a combine harvester where it is separated. Most of the straw and detritus does not have to travel into the combine.

A cutting or rotating mechanism can be positioned at clog point 720 to cut or move straw that wraps around clog point 720 between the upper apparatus and the lower apparatus.

The grain heads contact the drum as they enter the combine. A sickle bar cutter that cuts the grain stalks as they enter the combine was used in an exemplary prototype, although the machine can also be designed to operate as a stripper that does not necessarily cut grain stalks. The rotating drum draws stalks of grain into the combine, threshes the stalks of grain between the drum and an outer shell as the grain stalks travel around and upward. The straw, grain, and chaff are then expelled at the top of the drum.

Certain exemplary prototype combine harvesters expel grain forward, above a height of the standing grain in front of the machine, and onto an upper side of the intake and grain separating draper. The draper can be made of netting, mesh, plastic fencing, or similar material with apertures sized to allow grain to pass through the holes. The grain is collected, and straw and chaff are separated and moved aside. A larger, commercial scale application of exemplary mechanisms can utilize a second thresher-conveyance apparatus to expel the straw, grain, and chaff toward a rear of the machine, as well as one or more augurs, conveyors, or similar devices to move grain, straw, and chaff (as opposed to having such materials fall by gravity).

The simplified combine harvester is unique. It is much simpler than large industrial combines or certain exemplary small or micro-combines. As such, the simplified combine harvester is much easier and cheaper to manufacture. The simplified combine harvester has only about 20% as many moving parts as even a micro-combine. The simplified combine harvester can be manufactured in small or moderately sized manufacturing facilities. The operation of exemplary machines is relatively simple to understand, operate, and maintain.

In certain exemplary embodiments, all moving parts can turn in the same direction, thus no gearboxes or changes of direction of mechanical power are utilized. The simplified combine harvester can have fewer moving parts than larger combines, and thus less internal friction. Certain exemplary embodiments can be “ground driven”, which means that exemplary machines can be pulled by draft animals, a small tractor, two-wheeled tractor, or tiller, and powered by belts, gears, drive chains or other similar mechanisms from its own wheels.

The simplified combine harvester can harvest tall grain and grain of variable height. This is a substantial benefit over certain micro-combines. The mechanisms used on exemplary small combine harvesters can also be used on larger machines. The thresher-conveyance apparatus can allow for faster harvest of grain when used on a larger combine harvester. Utilization of exemplary machines disclosed herein can be of global benefit.

Certain exemplary simplified combine harvesters are based on two mechanisms, those being an intake and grain separating draper, and a thresher-conveyance apparatus. Both mechanisms perform numerous functions that are performed by many separate mechanisms on other exemplary combine harvesters. The use of these two mechanisms allowed creation of a prototype that was dramatically simpler than other combine harvesters.

As the simplified combine-harvester moves through a field of grain, the stalks of grain are first contacted by the intake and grain separating draper, as illustrated in FIG. 1. This draper can be set at roughly a 45-degree angle, protruding in front of the combine harvester, such that the top of the draper is high enough to reach to the top of tall grain stalks and bend them down into the combine harvester. This is a significant advantage over certain micro-combines currently on the market which can only harvest grains of a very consistent, modest height. This active intake mechanism is also advantageous over exemplary “stripper” combine harvester designs that rely on uniform grain height to perform well. Certain exemplary simplified combine harvesters can harvest many kinds of grain, at various heights, under varying field conditions.

Certain exemplary simplified combine harvester prototypes can have a sickle bar cutter that clips off grain stalks in a similar manner to certain exemplary combine harvester headers. The grain stalks are then fed into the thresher-conveyance apparatus which uses a large, rotating drum to both thresh the grain and move the straw, grain, and chaff to a new, elevated position on the machine. A shell covers the drum of the thresher-conveyance apparatus. The shell has an opening close to the ground where stalks of grain are pulled in, and another opening at the top the drum where grain, straw, and chaff are expelled. The grain is threshed as it travels between the rotating drum and the outer shell.

The drum is mounted in the combine at a height such that the bottom of the drum is at the lowest level needed for harvesting grain, that being the intake height of the combine harvester. The intake height of certain exemplary simplified combine harvesters can be adjustable. For modern, short, even-height grain (such as modern dwarf wheat), the simplified combine harvester can be operated as a stripper without a sickle bar cutter. A draper and sickle bar cutter allow for the harvest of a wider range of grain heights and are thus desirable for harvesting grain under a wider diversity of conditions.

Changes in the size of the drum used in a thresher-conveyance apparatus alters both the intake angle as the drum first contacts the grain stalks, and the travel distance of the grain stalks as they are traveling between the drum and outer shell and thus being threshed. The size of the drum also impacts the height of the point at which the threshed grains, stalks, and chaff are expelled, and thus the distance to ground level that allows for gravity assistance in the grain cleaning process.

A rotational velocity of the drum can be adjustable. For example:
cone pulleys can be utilized;
a variable speed hydraulic drive can be utilized;
a variable speed electrical drive.

It can be advantageous to adjust the speed of the thresher-conveyance apparatus to accommodate the size and softness of various crops to be harvested.

The grain is threshed as the stalks of grain pass between the drum and the outer shell, both of which have protrusions or lateral bars to facilitate threshing. The drum protrusions or lateral bars (bars, notched bars, flails, paddles, etc.) hereinafter and on the drawings are referred to as “thresher bars”. The outer shell protrusions or lateral bars are hereinafter and, on the drawings, referred to as “impedance bars”, though differing shapes of material may be advantageously employed other than bars as such. FIG. 5 illustrates some of the various options of shapes of thresher bars and impedance bars.

The impedance bars of the outer shell are adjustable inward, outward, toward, and away from the drum either as one unit or each separately. The thresher bars and impedance bars may or may not have slots, flails, or be made of angled or notched materials such that they pass “through” each other without colliding. The purpose of both the thresher bars and impedance bars is to enhance the threshing process. Closer clearances, the use of flails, or the use of notched or angled thresher bars and impedance bars allows for a more aggressive threshing process. The thresher bars both thresh the grain and draw the grain stalks into the combine harvester.

An exemplary prototype utilized continuous flat bars. Such continuous bars are advantageous in that they are less likely to tangle with longer grain stalks, vines, or weeds, and thus less likely to clog the combine harvester. Bars shown in FIG. 5 illustrate, among others, angular notched thresher and impedance bars. Angular notched bars achieve a more aggressive threshing for harder to thresh grains but are more likely to tangle and clog with the material moving through the combine harvester. Square notched bars shown in FIG. 5 which, like angular notched bars, enhance threshing aggressiveness while also increasing the potential for clogging. Square notched bars that utilize flails is another aggressive threshing option. If flails are used, they are attached to the thresher bars, not the impedance bars, as the impedance bars are stationary, and the centrifugal force of the rotating drum would activate the threshing action of the flails. The choice of the various thresher and impedance bar options are many and not limited to those shown here. Which bars are used is dependent on which crops are being harvested under what conditions, and the balance of concerns regarding the efficacy of the intake and threshing weighed against the potential for tangling and clogging of straw and weeds as they pass through the combine harvester. The number of thresher bars and impedance bars can be varied.

A total distance traveled by grain heads as they travel between the drum and the outer shell is related to drum height. Narrowing a clearance between the thresher bars and impedance bars and increasing the drum speed (rotational velocity) will facilitate a more aggressive threshing process as can be utilized for smaller, harder grains. Increasing the number of thresher bars and impedance bars will increase an intensity of threshing. Larger grains or legumes, or softer grains, benefit from a less aggressive threshing process, which is achieved by a retraction of the impedance bars and/or a slower drum speed.

Grain, straw, and chaff are expelled from the top of the drum by centrifugal force. The grain, straw, and chaff fall on the upper side of the moving intake and grain separating draper. The draper is in motion any time the simplified combine harvester is in operation. The lower side of the draper is pulling the grain stalks into the simplified combine harvester while the upper side of the draper is both carrying straw up and away from the combine harvester and filtering grain through the holes in the mesh or netting of the draper. The draper can have draper conveyance bars that facilitate both pushing the grain stalks into the combine harvester on the lower side and pushing the straw up and away from the combine on the upper side. The draper conveyance bars on the draper on an exemplary prototype comprised aluminum angle. In certain exemplary embodiments, the draper can comprise synthetic materials with draper conveyance bars molded into the draper material. Other methods of enhancing the capacity of the draper to push material into and away from the combine can be utilized.

For the sake of making a small, inexpensive combine harvester, the grain falls through the holes in the conveyance and grain separating draper into an angled trough and travels to the side of the draper assisted by gravity and the vibration of the running machine. Much of the chaff also falls through the holes in the draper. In certain exemplary embodiments, a fan is set to the side of the draper blows air through the falling grain and chaff between the upper and lower parts of the draper. The chaff is blown to the side. The grain catchment has a cover to prevent chaff and straw from falling into the catchment. The grain can also be bagged if a holder is put in place such that a bag is held under the grain trough. On a larger combine, an augur, conveyor, or similar device can catch the grain as it comes out of the draper and move the grain to the rear of the machine.

Certain exemplary embodiments comprise a cover over the upper side of the draper with stationary draper impedance bars set parallel to the moving bars of the draper. The distance from the draper cover to the draper can be adjustable. The draper impedance bars agitate the straw and cause it to roll as it proceeds up the draper. This helps free the grain that remains entangled in the straw so that it can fall through the draper.

As the straw moves around the top of the draper, it is pushed to the underside of the draper by the moving draper bars and gravity. Straw expulsion bars are stationary and set at a sharp angle (approximately 45 degrees or more) relative to the draper conveyance bars. The distance from this part of the draper cover to the draper can also be adjustable. The force of straw pushing against the straw creates a modest reciprocal lateral force on the moving draper. The sides of the draper cover serve as rails and keep the draper in place. The straw expulsion bars push the straw out the side of the draper. On a larger combine, augurs, conveyors, or similar mechanisms can be used to facilitate the movement of the straw.

A narrow draper can allow for gravity to move both the grain and the straw to the side, whereas a use of a wider draper can utilize augurs, conveyors, and/or similar mechanisms to move the grain and straw out and away from the draper as the machine is operating. A more rigid structure might also be used to perform the same functions as the draper, such as a drum covered with mesh or screening.

The use of a thresher-conveyance apparatus on a larger combine harvester can employ additional vibrating or rotating screens, or other commonly employed grain cleaning devices, such that the grain can be further filtered and cleaned.

A fan can be utilized to blow air through the falling grain is it leaves the draper to blow away the chaff. Exemplary prototypes represent an inexpensive configuration of the simplified combine harvester that produces grain that is sufficiently cleaned of debris to be edible. Any of various grain cleaning devices can be added to the simplified combine harvester, though such will increase the cost and complexity of the machine.

The simplified combine harvester as represented here will harvest wheat, rice, millet, barley, sorghum grain, oats, rye, and other similar small grains. The harvest of beans, corn, or other larger seeded grains may utilize modified machines.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adapter—a device used to effect operative compatibility between different parts of one or more pieces of an apparatus or system.
adjust—to change to a sought state.
adjustable—capable of being changed to a sought state.
along—at a point on.
and/or—either in conjunction with or in alternative to.
angled—having a first portion that is sloped and forms an angle with a second portion.
aperture—an opening in something.
apparatus—an appliance or device for a particular purpose.
around—in, along, or through a pathway.
associate—to join, connect, and/or relate.
away from—in a different direction from.
bar—a length of material.
belt—a flexible band used to drive a part of a machine.
bend—to force into another shape.
can—is capable of, in at least some embodiments.
cause—to produce an effect.
chaff—a protective casing of the seeds of grains.
close to—near to.
combine harvester—a machine constructed to harvest a variety of grain crops. The name derives from its combining four separate harvesting operations—reaping, threshing, gathering, and winnowing-to a single process utilizing a single machine.
comprising—including but not limited to.
configure—to make suitable or fit for a specific use or situation.
connect—to join or fasten together.
constructed to—made suitable or fit for a specific use or situation.
contact—to touch.
continuous—marked by uninterrupted extension in space.
convert—to transform, adapt, and/or change.
conveyor—a subsystem constructed to transport materials from one location to another.
couple—to link in some fashion.
coupleable—capable of being joined, connected, and/or linked together.
create—to bring into being.
define—to establish the outline, form, or structure of.
determine—to obtain, calculate, decide, deduce, and/or ascertain.
device—a machine, manufacture, and/or collection thereof.
down—toward a lower elevation relative to the surface of the earth.
draper conveyance bar—a part of a intake and grain separating draper that extends beyond or above a surface of the draper.
drum—a substantially cylindrical machine component.
enter—to go into.
expel—to force removal from a given location.
facilitate—to help bring about.
flail—a machine component constructed for threshing grain; (v) to thresh (grain) with a flail.
front—a forward surface of a machine when the machine is operating as designed.
grain—a small, hard, dry fruit that is harvested for human or animal consumption.
grain stalk—a plant that comprises a stem and at least one small, hard, dry fruit that is harvested for human or animal consumption.
ground level—an elevation above a surface of the earth.
header—a grain-harvesting subsystem that cuts off grain heads and elevates the grain heads to a wagon or conveyor.
headfirst—entering something with a top portion of a grain stalk entering first.
height—a dimension of an uprightly oriented object along a direction that is substantially perpendicular to the ground.
high enough—sufficient in elevation to perform a particular function.
impedance bars—bars coupled to a shell of a rotating drum and placed such that they serve to slow the flow of material and agitate said material as it passes through an apparatus.
initialize—to prepare something for use and/or some future event.
install—to connect or set in position and prepare for use.
intake and grain separating draper—a subsystem that pulls grain into a combine harvester, and filters grain from straw, the subsystem comprises a fabric or elastomer apron that is constructed to feed grain into other parts of the combine harvester.
into—an action with the result that something becomes enclosed or surrounded by something else.
inward—toward an interior of a machine.
lean—to incline or be bent from a vertical orientation.
length—a longest extent of something as measured from end to end.
material—something used in making items.
may—is allowed and/or permitted to, in at least some embodiments.
mesh—a fabric comprising spaced apertures.
method—a process, procedure, and/or collection of related activities for accomplishing something.
move—to go or pass to another place or in a certain direction.
netting—an open-meshed fabric twisted, knotted, or woven together at substantially regular intervals.
notched—having an indentation or incision on an edge or surface.
outward—away from an interior of a machine.
partially—to a limited extent.
pass through—to enter one side and exit out of an opposite or another side of something.
plurality—the state of being plural and/or more than one.
predetermined—established in advance.
protrude—to extend beyond or above a surface.
provide—to furnish, supply, give, and/or make available.
pulled in—forced toward.
push—to press with a force.
reach—to extend to.
rear—a back of something.
receive—to get, take, acquire, and/or obtain.
remove—to take something out of a space.
repeatedly—again and again; repetitively.
request—to express a desire for and/or ask for.
rotate—to move or cause to move around an axis or center.
select—to make a choice or selection from alternatives.
self-propelled—capable of impelled motion without energy from something else.
set—a related plurality.
shell—an encasement.
sickle bar cutter—the complete cutting mechanism of a grain harvester that comprises cutting blades, guards, and a bar to which the cutting blades and guards are coupled.
side—a bounding portion of an object.
simplified—having a lower complexity compared to certain other systems.
slope—with respect to a first point and a second point that are intersected by a straight line, a ratio of the change in the ordinal value from the first point to the second point, to the change in the abscissal value from the first point to the second point.
small—a machine that is approximately three feet or approximately one meter in width.
stand—to be in a substantially erect position relative to the surface of the Earth.
store—to place, hold, and/or retain.
straw—stalks of grain after grain and chaff have been removed.
strip—to remove by force.
stripper—a system constructed to plucks ears of grain without winnowing, and which substantially leaves straw standing.
substantially—to a great extent or degree.
support—to bear the weight of, especially from below.
surround—to enclose around over at least a portion of a perimeter of an object.
system—a collection of mechanisms, devices, machines, articles of manufacture, processes, data, and/or instructions, the collection designed to perform one or more specific functions.
thresher—a subsystem that removes the seeds from stalks and husks.
thresher bars—bars coupled to a rotating drum.
thresher-conveyance apparatus—a farm equipment subsystem that threshes grain, that is, it removes the seeds from stalks and husks, and conveys grain, straw, and chaff to another location within the machine. The subsystem functions by beating grain stalks to make seeds fall out.
top—an uppermost portion of relative to the earth.
toward—in the direction of.
transmit—to send, provide, furnish, and/or supply.
travel—to move in a given direction or path.
trough—a conduit, drain, or channel via which materials are conveyed.
up—in a direction away from the Earth's surface.
upper—above relative to the Earth's surface.
upward—in a direction away from the surface of the earth.
user—any person, organization, process, device, program, protocol, and/or system that uses a machine.
via—by way of and/or utilizing.
winnowing fan—a powered machine constructed to create a flow of air via which chaff is separated from grain.
without—substantially lacking.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A simplified combine harvester for threshing grain stalks, comprising:
an intake and grain separating draper, the intake and grain separating draper protruding from a front of the simplified combine harvester, a top of the intake and grain separating draper configured to be high enough to reach a top of the grain stalks, the intake and grain separating draper configured to bend the grain stalks down into the simplified combine harvester;
a first thresher-conveyance apparatus, the first thresher-conveyance apparatus including:
a sickle bar cutter, the sickle bar cutter configured to cut the grain stalks as the grain stalks enter the first thresher-conveyor apparatus; and
a rotating drum, the rotating drum at least partially surrounded by a shell, the rotating drum configured to draw grain stalks into the first thresher-conveyance apparatus, the grain stalks being threshed between the rotating drum and the shell as the grain stalks travel around and upward around the rotating drum,
wherein the rotating drum and the shell are configured to expel straw, grain, and chaff of the grain stalks at a top of the rotating drum.

2. The simplified combine harvester of claim 1, wherein:
the intake and grain separating draper has draper conveyance bars that facilitate both pushing the grain stalks into the simplified combine harvester on a lower side and pushing the straw up and away from the simplified combine harvester on an upper side.

3. The simplified combine harvester of claim 1, wherein:
the rotating drum includes thresher bars.

4. The simplified combine harvester of claim 1, wherein:
the rotating drum includes thresher bars with flails.

5. The simplified combine harvester of claim 1, wherein:
the shell includes impedance bars, the impedance bars configured to be adjustable inward, outward, toward, and away from the rotating drum by a user.

6. The simplified combine harvester of claim 1, wherein:
the rotating drum includes thresher bars; and
the shell includes impedance bars, wherein the thresher bars or the impedance bars include angled or notched materials such that the thresher bars and the impedance bars pass through each other without contact as the rotating drum rotates.

7. The simplified combine harvester of claim 1, wherein:
the rotating drum includes thresher bars, wherein the thresher bars are disposed continuously along a first width of the rotating drum; and
the shell includes impedance bars, wherein the impedance bars are disposed continuously along a second width of the shell.

8. The simplified combine harvester of claim 1, wherein:
the intake and grain separating draper is configured to:
push the grain stalks that are standing grain stalks downward;
cause the standing grain stalks to lean into a thresher; and
cause the standing grain stalks to enter the simplified combine harvester headfirst, whereupon the standing grain stalks come into contact with the first thresher-conveyance apparatus.

9. The simplified combine harvester of claim 1, wherein:
the shell defines a first aperture close to ground level where the grain stalks are pulled in, and a second aperture at a top of the rotating drum where the straw, the grain, and the chaff are expelled.

10. The simplified combine harvester of claim 1, wherein:
the intake and grain separating draper includes a mesh.

11. The simplified combine harvester of claim 1, wherein:
the intake and grain separating draper includes netting.

12. The simplified combine harvester of claim 1, wherein:
the intake and grain separating draper defines apertures sized such that the grain passes through the apertures.

13. The simplified combine harvester of claim 1, wherein:
the simplified combine harvester is self-propelled or pulled by another machine.

14. The simplified combine harvester of claim 1, wherein:
a rotational velocity of the rotating drum is adjustable by a user.

15. The simplified combine harvester of claim 1, wherein:
the simplified combine harvester includes sloped troughs, the sloped troughs configured to move the grain and the straw.

16. The simplified combine harvester of claim 1, further comprising:
a second thresher-conveyance apparatus, the second thresher-conveyance apparatus configured to expel the straw, the grain, and the chaff toward a rear of the simplified combine harvester; and
one or more conveyors, the one or more conveyors configured to move the straw, the grain, and the chaff through the simplified combine harvester.

17. The simplified combine harvester of claim 1, further comprising:
a winnowing fan that is configured to blow air through the grain when the grain is falling to remove the chaff from the grain.

18. A method for a simplified combine harvester, the method comprising:
providing a thresher-conveyance apparatus, the thresher-conveyance apparatus including a rotating drum, the rotating drum at least partially surrounded by a shell;
harvesting grains using the thresher-conveyance apparatus;
stripping grain heads using the thresher-conveyance apparatus; and
operating the thresher-conveyance apparatus as a stripper without using a sickle bar cutter.

19. A simplified combine harvester for threshing grain stalks, comprising:
an intake and grain separating draper;
a thresher-conveyance apparatus, the thresher-conveyance apparatus including:
a sickle bar cutter, the sickle bar cutter configured to cut grain from the grain stalks as the grain stalks enter the thresher-conveyance apparatus; and
a rotating drum, the rotating drum at least partially surrounded by a shell, the rotating drum configured to draw the grain stalks into the thresher-conveyance apparatus, the grain stalks being threshed between the rotating drum and the shell as the grain stalks travel around and upward around the rotating drum, wherein the rotating drum and the shell are configured to expel straw, grain, and chaff at a top of the rotating drum.

20. The method of claim 18, further comprising adjusting a plurality of impedance bars, which are disposed at the shell, in directions that are:
inward toward the rotating drum; and
outward away from the rotating drum and toward the shell;
wherein a plurality of thresher bars are disposed at the rotating drum.
